(19) United States
(12) Patent Application Publication
(10) Pub. No.: US 2003/0202836 A1
(43) Pub. Date: Oct. 30, 2003

(54) Ink marker with an automatic open-close ball cap

(76) Inventor: Kun Yuan Tong, Albany, GA (US)

Correspondence Address: KUN-YUAN TONG, 2308 W. Doublegate Dr., Albany, GA, 31707, US

(21) Appl. No.: 10/133,864

(22) Filed: Apr. 29, 2002

(51) Int. Cl. B43K 24/02; B43K 7/12

(52) U.S. Cl. 401/108; 401/107

(57) ABSTRACT

An improved ink marker with an automatic open-close ball cap contains an inner ink shaft and an outer supporting shaft. The inner ink shaft is snugly surrounded by a washer, is installed inside the outer supporting shaft, and has a ball cap to cover and seal the opening of outer supporting shaft to create an air tight chamber to prevent the ink marker from drying out. The ball cap is fixed to the tip of the inner ink shaft by a pair of curved spring wires which have the capacity to spring back to its original curved position and swing the ball cap away from the tip of ink wick. The force to open and close the improved ink marker with an automatic open-close ball cap is provided by a spring coil and manual pressure by a person's finger. A locking device is provided to keep the improved ink marker with an automatic open-close ball cap in the open position.

### BACKGROUND OF THE INVENTION

An ink marker needs a tight cap to prevent it from drying out. Its cover has to be removed and capped with two hands before and after every use. Because it is very cumbersome to remove and cap the cover off and on, the user of an ink marker often leaves an ink marker open while using it, letting it dry out. The cover of the present improved ink marker with an automatic open-close ball cap can be opened automatically by pushing down the shaft and closed automatically by pushing its clip with one finger just like opening and closing a ball pen with one hand.

### BRIEF DESCRIPTION OF THE INVENTION

The improved ink marker with an automatic open-close ball cap consists of an inner ink shaft and an outer supporting shaft. The inner ink shaft contains an ink wick soaked with color ink in its chamber and a ball cap fixed to its tip by two curved spring wires and a ring base. The outer supporting shaft contains a shaft, a curved flexible clip, a spring coil, a washer and a tip. The ball cap is larger than the opening of the tip of the outer supporting shaft. When the tip of the inner ink shaft is pushed out of the opening of the tip of the outer supporting shaft, the two curved spring wires hold the cap sideways away from the tip of ink marker. When the tip of inner ink shaft is pulled into the chamber of the outer supporting shaft by a spring coil, the ball cap is brought back to and seals the opening of the tip of the outer supporting shaft by the two curved spring wires. A washer is fixed at the bottom of the tip of the outer supporting shaft and snugly surrounds the outer surface of the inner ink shaft to create an air tight chamber at the tip of the outer supporting shaft between the washer and the ball cap to prevent the ink marker from drying out.

### DETAIL DESCRIPTION OF THE DRAWINGS

FIG. 1 is a perspective view of an ink marker with an automatic open-close ball cap when it is closed.

FIG. 2 is a perspective view of an ink marker with an automatic open-close ball cap when it is open.

FIG. 3 is a dissected view of an ink marker with an automatic open-close ball cap when it is closed.

FIG. 4 is a perspective view of a curved flexible clip, a spring coil, a washer and a set of ball cap of an ink marker with an automatic open-close ball cap.

FIG. 5 is a perspective view of the shaft and the tip of the outer supporting shaft of an ink marker with an automatic open-close ball cap.

FIG. 6 is a perspective view of an inner ink shaft of an ink marker with an automatic open-close ball cap when its stopper is detached from its shaft.

FIG. 7 is a perspective view of an ink wick of the inner ink shaft of an ink marker with an automatic open-close ball cap.

### DETAILED DESCRIPTION OF THE INVENTION

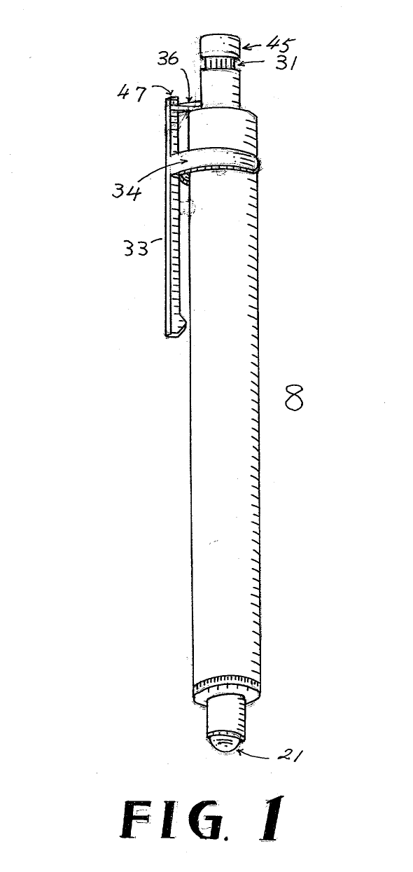

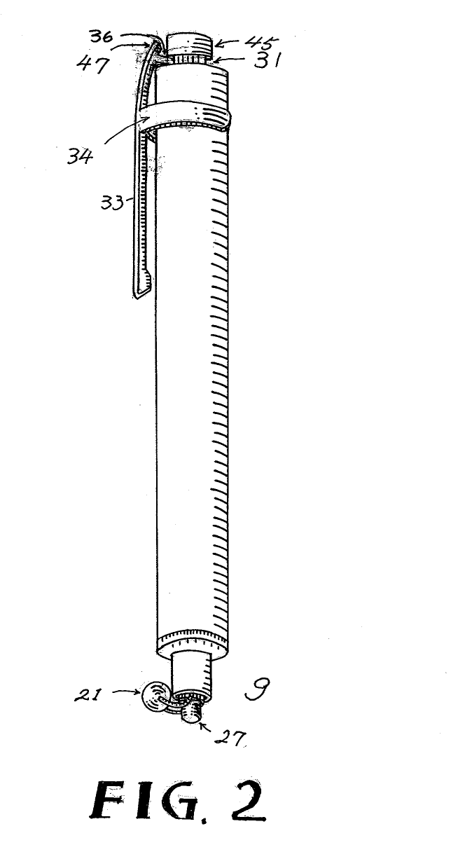

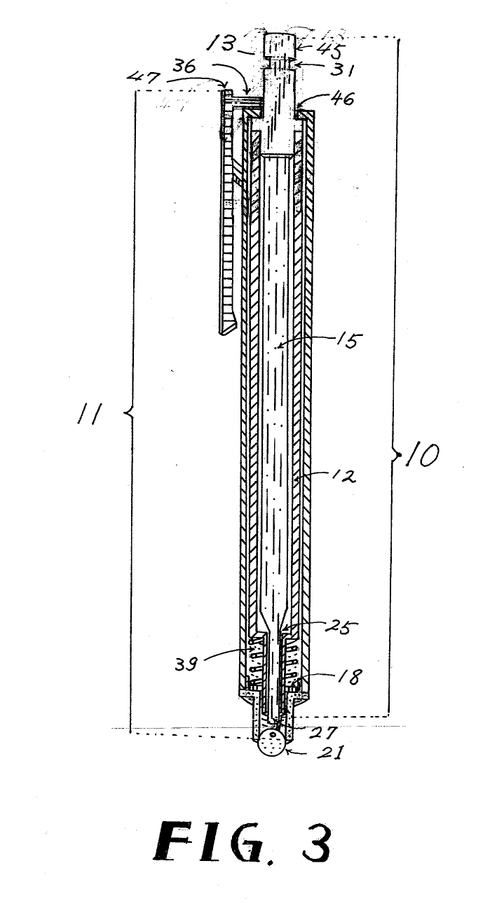

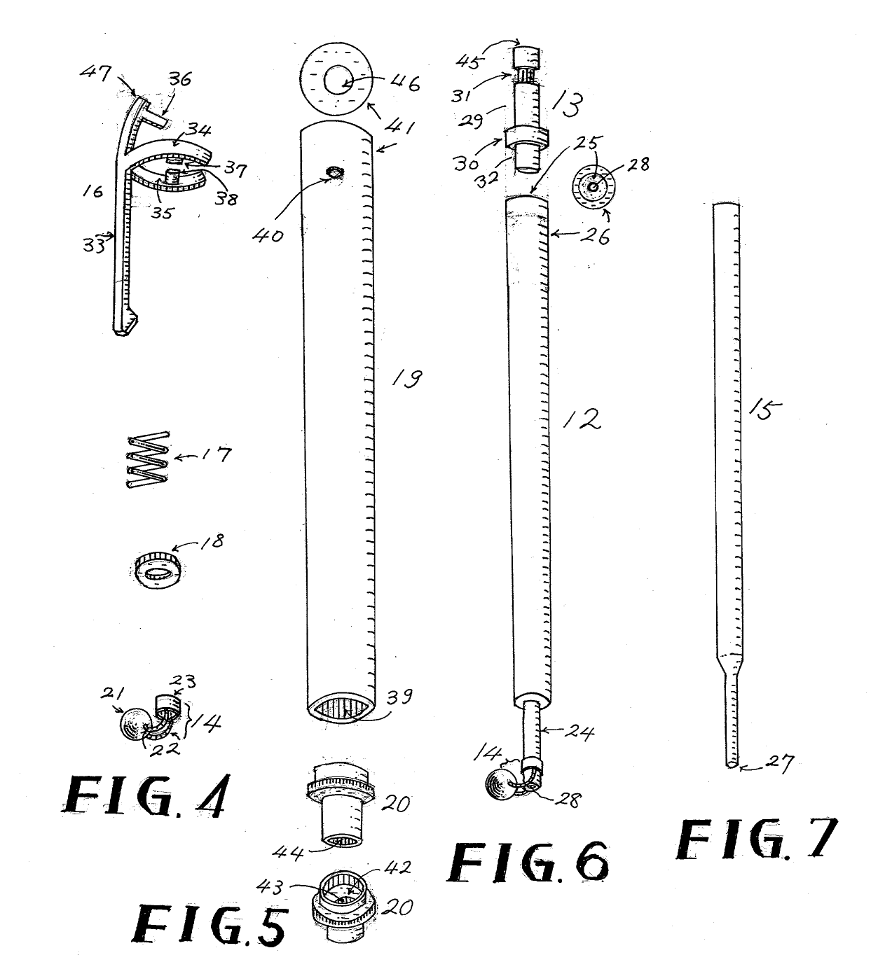

Referring now in detail to the drawings, numeral 8 of FIG. 1 illustrates an improved ink marker with an automatic open-close ball cap in the closed position. Numeral 9 of FIG. 2 illustrates the improved ink marker with an automatic open-close ball cap 8 in the open position. The improved ink marker with an automatic open-close ball cap 8 contains an inner ink shaft 10 and an outer supporting shaft 11 as illustrated in FIG. 3. The inner ink shaft 10 contains a shaft 12, a stopper 13, one set of ball cap 14 and an ink wick 15, as illustrated in FIGS. 3, 4, 6 and 7. The outer supporting shaft 11 contains a clip 16, a spring coil 17, a washer 18, a shaft 19 and a tip 20, as illustrated in FIGS. 3, 4 and 5. The set of ball cap 14 contains a ball cap 21, a pair of curved spring wires 22 and a ring base 23, as illustrated in FIG. 4. The set of ball cap 14 is fixed to the tip 24 of the inner ink shaft 10 as illustrated in FIGS. 3 and 6. The ink wick 15 is inserted into the chamber 25 of ink shaft 12, as illustrated in FIG. 3. The stopper 13 is inserted into the chamber 25 at the top 26 of the inner ink shaft 10, as illustrated in FIGS. 3 and 6. The tip 27 of ink wick 15 comes out of the hole 28 of inner ink shaft 12, as illustrated in FIG. 2. The stopper 13 has a stem 29, a wing 30 at one end and a notch 31 at the other end, as illustrated in FIGS. 3 and 6. The winged end 32 of the stopper 13 is inserted into the chamber 25 at the top 26 of shaft 12 of the inner ink shaft 10, as illustrated in FIGS. 3 and 6. The curved flexible clip 16 has a stem 33, one pair of identical wings 34 and 35, a bar 36 and a point 47, as illustrated in FIGS. 1, 2, 3 and 4. The bar 36 locks into the notch 31 when the stopper 13 of inner ink shaft 12 is pushed down into the chamber 39 of the shaft 19 of the outer supporting shaft 11, as illustrated in FIG. 2. Two identical protuberances 37 and 38 of the wings 34 and 35 of clip 16 can be of any shape besides round shape and are located at the middle of the inner sides of wings 34 and 35, as illustrated in FIG. 4. The pair of identical holes 40 has the same shape as that of the identical protuberances 37 and 38 and is located at the proximal portion and opposite side of the outer supporting shaft 19 to install the protuberances 37 and 38 to prevent clip 16 from tilting in order to keep bar 36 a constant force against the stem 29 of stopper 13, as illustrated in FIGS. 1 and 3. The washer 18 is fixed to the bottom 42 of the tip 20 of the outer supporting shaft 11, as illustrated in FIGS. 3, 4 and 5. The spring coil 17 is placed on top of washer 18 and surrounds the tip 24 of the inner ink shaft 10, as illustrated in FIGS. 3, 4 and 6. The tip 24 of inner ink shaft 10 is first inserted into the hole 43 and passes out of hole 44 of the tip 20 of the outer supporting shaft 11 before the set of ball cap 14 is fixed at its end, as illustrated in FIGS. 5 and 6. The top 45 of stopper 13 is passed out of hole 46 at the top 41 of shaft 19 of the outer supporting shaft 11, as illustrated in FIGS. 1, 2, 3, 5 and 6. When the top 45 of the inner ink shaft 10 is pressed downwards against the force of spring coil 17 to the point that bar 36 is locked into notch 31, the set of ball cap 14 and the tip 27 of ink wick 15 are pushed out of the hole 44 of tip 20 of the outer supporting shaft 11 and the pair of curved spring wires 22 swing the ball cap 21 outwards away from the tip 27 of ink wick 15 to facilitate writing, as illustrated in FIGS. 2 and 6. When the point 47 of the curved flexible clip 33 is pushed outwards to release bar 36 from notch 31, the spring coil 17 pushes the inner ink shaft 10 upwards to bring the ball cap 21 to cover and seal the hole 44 of tip 20 of outer supporting shaft 11, as illustrated in FIGS. 1 and 3. When the ball cap 21 covers and seals the hole 44, the washer 18, which is fixed at the bottom 42 of the tip 20 of outer supporting shaft 11, surrounds the tip 24 of shaft 12 snugly to create an air tight chamber in the tip 20 of outer supporting shaft 11 to prevent the ink marker from drying out. The wing 30 of stopper 13 is stopped at the top 41 of outer supporting shaft 11 because hole 46 is smaller than its diameter, as illustrated in FIGS, 3, 5 and 6. Shaft 19 of outer supporting shaft 11 is hollow and has two openings 39 and 46, as illustrated in FIGS. 3 and 5. Shaft 12 of inner ink shaft 10 is hollow and has two openings, 25 and 28, as illustrated in FIGS. 3 and 6. Ink wick 15 can be soaked with any kind of colored ink.

1. An ink marker with an automatic open-close ball cap composing of an inner ink shaft and an outer supporting shaft.

2. The said inner ink shaft in claim 1 comprising a hollow shaft, one set of ball cap fixed at its tip and a stopper, which has a notch at its top and a wing at its bottom, installed at the hollow shaft's top.

3. The said outer supporting shaft in claim 1 composing of a hollow shaft, a curved flexible clip, a spring coil, a washer and a tip.

4. The said washer in claim 3 is fixed at the bottom of the said tip of outer supporting shaft in claim 3 and surrounds snugly the said tip of inner ink shaft in claim 2 to provide an airtight seal but still allowing the tip to slide smoothly in and out.

5. The said one set of cap in claim 2 composing of a ball cap, one pair of curved sideward spring wires and a ring base, is fixed to the said tip of inner ink shaft in claim 2 and used to cover and seal airtight by the force of said spring coil in claim 3, the opening of said tip of outer supporting shaft in claims 1 and 3 and is able to swing the cap sideways away from to the tip of inner ink shaft, which contains an ink wick inside.

6. The said curved flexible clip in claim 3 has a bar, which locks into the notch of the said stopper in claim 2, a pair of semicircular wings, which each has a protuberance at its inner middle side of each wing, a stem and a point at its top which facilitates the release of the above mentioned bar from the said notch of stopper in claim 2.

7. The said stopper in claim 2 has a notch at its top to lock in the said bar in claim 6 and a wing end at its bottom to be stopped at the top of the said shaft of outer supporting shaft in claim 3.

8. The said hollow shaft in claim 3 of outer supporting shaft in claims 1 and 3 has two small identical holes, which can be of any kind of shape besides the round shape, at its top portion to install the said protuberances, which have the same kind and same size of shape as that of the above mentioned identical holes, in claim 6 in order to prevent the said curved flexible clip in claim 3 from tilting and to keep the said bar in claims 6 and 7 at a constant force towards the said stopper in claims 2 and 7 to lock into the said notch in claims 2, 6 and 7.
